(19) United States
(12) Patent Application Publication
(10) Pub. No.: US 2012/0034361 A1
(43) Pub. Date: Feb. 9, 2012

(54) Sous Vide Cooking Method

(75) Inventor: Cynthia Kowalyk, Hilton Head, SC (US)

(73) Assignee: Cinzia Enterprises, LLC

(21) Appl. No.: 13/106,156

(22) Filed: May 12, 2011

Related U.S. Application Data
(60) Provisional application No. 61/370,652, filed on Aug. 4, 2010.

(51) Int. Cl. A23L 1/01

(52) U.S. Cl. 426/523

(57) ABSTRACT

A sous vide cooking method for structured foods that may include solid, liquid and semi-solid components in a structured form, such as foods that are not homogeneous or are formed in layers. The method comprises the use of an unsealed inner container to hold the food in that structure and a sealable outer container from which air can be pumped. The inner container may be a serving container; the outer layer may be flexible, sealable food-grade plastic. Air is pumped from the outer container until it applies light pressure on the surface of the food in the inner container and then the food in the inner and outer containers is cooked in a preheated water bath until done.

### PRIORITY CLAIM

Priority is claimed to U.S. provisional patent application Ser. No. 61/370,652, filed 4 Aug. 2010, which is incorporated herein in its entirety by reference.

### BACKGROUND OF THE INVENTION

The term sous vide means “under vacuum” and is a style of cooking developed in the 1970's. The basic technique involves placing a food item in a food-grade plastic bag, pumping air from the bag, sealing it, and then submerging the bag in a water bath. The process works well for steaks and chops and has many advantages in terms of the quality of the cooked items as well as convenience. The process is also used for liquids by placing the liquid into the container and then carefully pressing as much air out of the bag as possible before sealing it or by placing the liquid in an unsealed container in a vacuum chamber and then sealing the container when the pressure in the chamber is reduced.

### SUMMARY OF THE INVENTION

According to its major aspects and briefly recited, the present invention is a cooking method that permits additional types of foods to be cooked using the basic sous vide method, namely, foods that may include solid, liquid or semi-solid components in a structured form, such as in layers. The method comprises the use of an inner container to hold the food in its structured configuration inside an outer container that serves as the vacuum barrier. The inner container may be a serving container. Because liquids are less tightly bound chemically than solids, pumping air from the outer container enclosing an inner container holding food that partially includes a liquid must be done with care so as to avoid pumping the food itself from the container. Accordingly, it is important to regulate the pressure applied to the inner container and to the food it contains by the outer container as air is evacuated from the outer container and causes the outer container to collapse against the inner container and onto the food itself. The use of containers preserves the structure of the food while it cooks and facilitates serving.

### BRIEF DESCRIPTION OF THE DRAWINGS

In the figures,

FIG. 1A is a side cross sectional view of a inner container inside a outer container, according to an embodiment of the present invention;

FIG. 1B is a side cross sectional view of a inner container inside a outer container, according to another embodiment of the present invention

FIG. 2 is a side view, partially cut away showing food in its outer container inside a water bath, according the present invention; and

FIG. 3 is a flow chart of the sous vide method, according to an embodiment of the present invention.

### DETAILED DESCRIPTION OF EMBODIMENTS

The present invention is a method for cooking food under vacuum, the so-called sous vide technique. The term “under vacuum” means under a partial vacuum, that is much but not all air is evacuated from the containers holding the food. Because the food to which the present method applies includes non-solid components, the chemical bonds holding it together are much less strong than those of the solid foods to which the sous vide method is most often applied in the prior art (such as steaks and chops). Accordingly, the vacuum pressure, while below that of atmospheric pressure, is not so far below atmospheric pressure that appreciable quantities of the non-solid components separate from the bulk of the food. The exact pressure will vary depending on the nature of the food to be cooked and will inevitably depend on a certain amount of trial and error. For example, a casserole of cheese sauce and cooked pasta can be cooked in a higher vacuum than a bowl of broth. Further description of the air evacuation process is provided below.

The term structured food means that the density of the food is not homogenous but may consist of different components, perhaps some being denser and others less dense, or some being more cohesive and other components being less cohesive. Those different components may be larger or smaller, distributed evenly throughout or arranged in layers. Importantly, the food preparer wishes to preserve their arrangement—inhomogeneity and order—during cooking. Of course, some foods change their character as a result of cooking, beginning as liquids and ending as solids; other foods soften as a result of cooking, such as potatoes and apples.

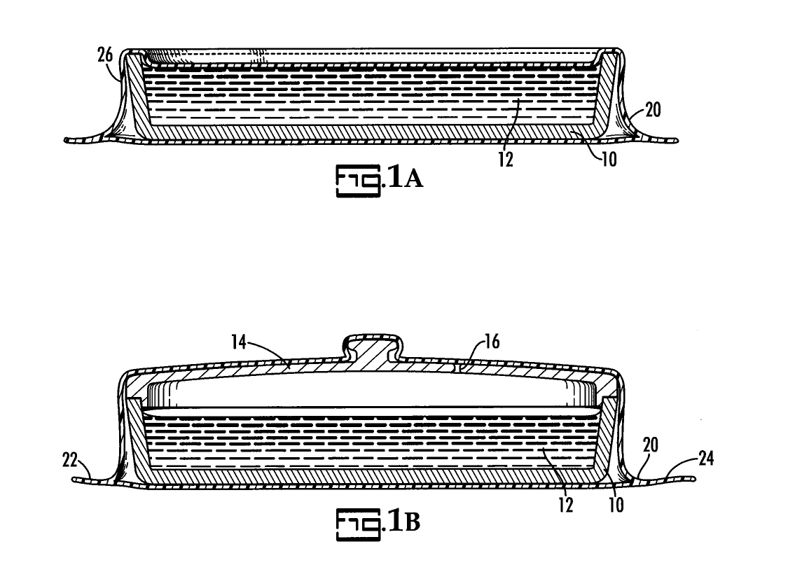

Referring now to the FIGS. 1A and 1B, food 12, which may contain solid components but may also contain liquid and semi-solid components is placed in a inner container 10. Inner container 10 may be a serving container, including an individual serving container, or a pan, ramekin, or other container with sides and a bottom that are sufficiently rigid to hold the food under partial vacuum without deforming. Inner container 10 may be a disposable container. As shown in FIG. 1B inner container 10 may have a top or lid 14 as long as the lid 14 is not tight fitting or is vented with one or more vent holes 16 to allow air to escape from inside inner container 10.

The food 12 in container 10 may be soup or a casserole or layered dish as well as food that has solid and softer foods intermingled. If food 12 is in layers and includes a solid layer, such as a layer of lasagna pasta, a solid layer is best placed on top of food 12.

Next, inner container 10 is placed inside an outer container 20. Outer container 20 is flexible and sealable and sized to receive inner container 10. Outer container 20 may be made of food-grade plastic of a type adapted to be heat-sealed. In one embodiment, outer container 20 is a tube of food-grade plastic dispensed from a roll by a device that forms heat seals 22 in one side of the tube and in the opposing side 24 where and as instructed by the user. Other devices use a plastic bag open on one end. Examples of vacuuming sealers are sold under the trademark SOUS VIDE SUPREME VACMASTER by Eades Appliance Technology LLC and FOODSAVER manufactured by Jarden Corporation. Other brands are available as well. Plural seals on either side of the inner container 10 made in outer container 20 assure an air-tight fit that prevents the intrusion of air before or after cooking, the intrusion of water during cooking in a water bath, and the loss of moisture or cooking juices from the food before, during and after cooking.

Other prior art vacuum machines may be used such as those generally referred to as vacuum chambers.

Before complete sealing, air is pumped from the inside of the outer container 20. As air is removed from outer container 20, its flexible sides will collapse to conform to the shape of inner container 10. If inner container 10 has no top 14, one of the sides 26 of outer container 20 will touch the surface of the food and come to apply pressure on the food. The pumping of the air from outer container 20 should be stopped while that pressure is light, that is, before the food begins to change from liquid to vapor in inner container 10 or is sucked up into an evacuation hose (not shown). Accordingly, pumping air from outer container 20 should proceed carefully, especially once outer container 20 conforms to the shape of inner container 10. Pulsing the pumping operation provides good control and allows the atmosphere inside outer container 20 to equilibrate between pulses.

Once the partial vacuum inside outer container 20 is obtained, outer container 20 may be sealed.

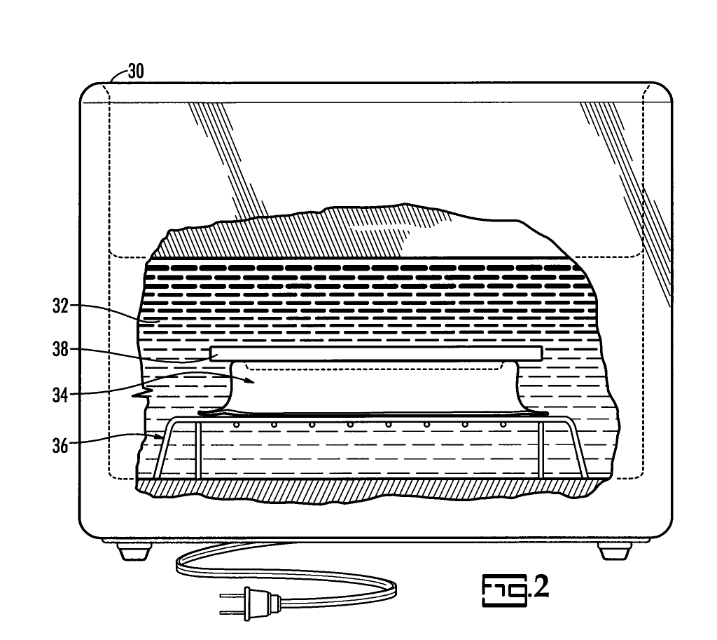

Meanwhile, as seen in FIG. 2, a water bath 30 is heated to raise the temperature of water 32 in it to a pre-selected temperature. Once water bath 30 is at the pre-selected temperature, outer container 34 may be submerged in water bath 30, perhaps with the assistance of a weight 38 such as a plate, and may be placed on a rack 36. Outer container 34 remains in water bath 30 for at least a pre-selected time. Alternatively, if convenient, outer container 34 may be placed in the water bath prior to it reaching the preselected temperature. Thereafter, outer container 34 may be removed from water bath 30, opened and the inner container removed and served, or it may, be chilled in an ice bath and then refrigerated for reheating and serving at a later time. Depending on the time between completion of cooking in water bath 30 and the reheating, outer container 34 may be refrigerated at nominal refrigerator temperatures such as 7°-13° C. or at colder refrigerator freezer temperatures, such as 0° C. or colder.

As an alternative to the foregoing process, after sealing the outer container, the outer container may be refrigerated to freeze it before placing it in a water bath. This freezing step may be suitable in killing parasites in certain foods such as fish.

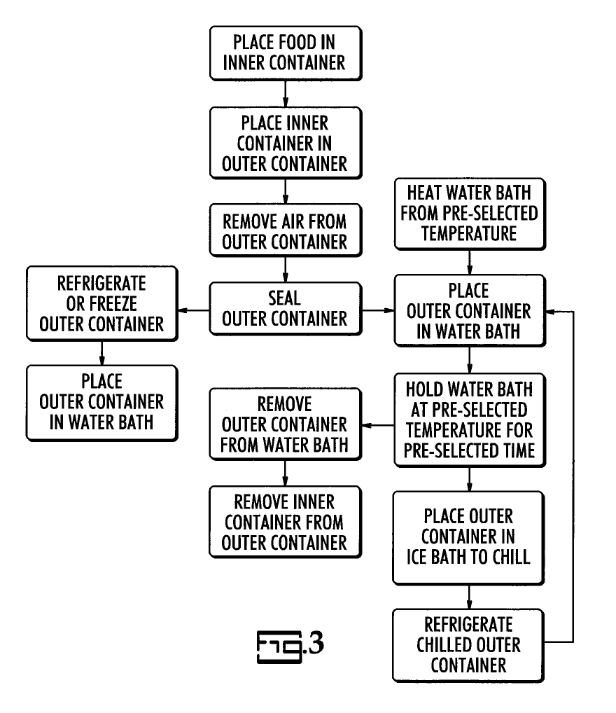

Referring now to FIG. 3, there is illustrated a flow chart showing the present method including optional steps. As FIG. 3 shows, the present process begins when food is placed in a container which becomes the inner container. The inner container has reasonable rigid sides and a bottom, and may have a top if the top is vented or at least is not sealed so that when the air is evacuated from outside the inner container, air is not trapped inside inner container. The inner container is then placed inside the outer container, which is a flexible, heat-proof, sealable container such as food-grade, heat sealable, heavy-weight plastic, preferably a transparent plastic. Before sealing the outer container, air is removed by pumping from the inside of outer container to create a partial vacuum. Air removal is stopped when outer container has collapsed and conformed to the exterior shape of inner container and is applying a light pressure on the surface of food that it touches. If inner container has a lid, then air removal is stopped when the outer container is applying light pressure to the surface of the lid. The outer container is then sealed so that air and water cannot intrude into outer container and food cannot escape from outer container.

Meanwhile, water in a water bath is heated to a pre-selected temperature. When the water has heated to the pre-selected temperature, the outer container with the food in the inner container safety sealed inside it is immersed in the water of the water bath. If the food is a liquid that has low viscosity, outer container may placed so that the inner container is right-side-up. A rack may be used to hold the outer container in the water and also to hold multiple containers with multiple food items to cook in the water bath at the same time.

The temperature of the water in the water bath is maintained at the pre-selected temperature for at least a pre-selected time while the food in the inner container inside the outer container cooks to doneness. The outer container may be left in the water bath beyond the pre-selected time, if convenient, as the food will not rise in temperature beyond the pre-selected temperature.

Once the pre-selected time has been reached, the outer container may be removed from the water bath, the seal broken and the inner container removed. If the inner container is a serving dish, perhaps an individual serving dish, such as a ramekin, it may be served directly. If not, the food may be transferred to a serving dish.

Alternatively, if the food will be consumed at a later date, the cooked food may be left in its inner container and in the outer container, and chilled in an ice bath. Once brought to a cold temperature, it may be refrigerated either at cold temperatures (such as 7°-13° C.) or at freezer temperatures (such as 0° C. or colder), depending on whether the food will be consumed within a few days or a longer period of time. When ready for consumption, the refrigerated, cooked food in outer container is simply re-immersed in a heated water bath and brought back up to the pre-selected temperature, and then it may be served immediately.

As an alternative part of the present method, after food is sealed in outer container, it may be refrigerated at cold temperatures (such as 0° C. or colder). Especially if food includes raw fish and shellfish, freezing in advance of cooking is recommended to kill parasites. When the food is to be cooked, the steps to follow are as provided above beginning with immersing the outer container in a preheated water bath.

The terms pre-selected times and pre-selected temperatures depend on the food being cooked. There are well known temperatures for beef, pork and poultry that identify the interior cooking temperatures that serve as the pre-selected temperatures for those foods. With a certain amount of experimentation, those of ordinary skill in the art can determine the minimum pre-selected times for achieving those temperatures in a water bath, particularly when the water bath has a temperature indicator. Additional indications of the pre-selected temperature and pre-selected time, particularly for food that is not solid and may be structured can be obtained by referring to the book SIMPLY SOUS VIDE by Cindy Kowalyk, copyright 2011 by Cinzia Enterprises LLC, which is hereinafter incorporated in its entirety by reference.

Many variations and modification to the foregoing embodiments will be clear to those skilled in the art of cooking from the foregoing description of preferred embodiments. For example, food cooked according to the present method but not completely consumed, may be placed within an outer container, and either refrigerated for a time or reheated in a water bath directly, as convenient. As another example, food cooked in a manner different from the present invention may be sealed in an outer container and later reheated in a water bath, according to the present method. These types of modifications and substitutions do not depart from the spirit and scope of the present invention, which is defined by the appended claims.

What is claimed is:

1. A method for cooking food, said method comprising the steps of:
(a) placing food in a inner container, said inner container having rigid sides, a rigid bottom and an uncovered top;
(b) placing said inner container inside a outer container, wherein said outer container is unsealed but sealable, having flexible sides so that a flexible side of said flexible sides faces said uncovered top so that said flexible side can touch said food in said container through said uncovered top;
(c) removing air from said outer container until said flexible side begins to apply pressure to said food through said uncovered top of said inner container;
(d) sealing said outer container;
(e) heating water in a water bath to a pre-selected temperature;
(f) placing said outer container with said inner container inside into said water bath;
(g) heating said first and outer container for at least a pre-selected time while maintaining said water bath at said pre-selected temperature; and
(h) removing said outer container from said water bath.

2. The method as recited in claim 1, further comprising the steps of:
(a) removing said inner container from said outer container; and
(b) serving said cooked food in said inner container.

3. The method as recited in claim 1, further comprising the steps of:
(a) placing said outer container with said inner container inside into an ice bath immediately after removing said outer container from said water bath to chill said food;
(b) refrigerating said outer container with said inner container inside;
(c) reheating said outer container in said water bath before removing said inner container from said outer container.

4. The method as recited in claim 1, wherein said air removing step further comprises the step of pumping said air from said outer container in pulses.

5. The method as recited in claim 1, wherein said food includes a solid element and other elements wherein said method further comprises placing said solid element on top of said other elements in said inner container.

6. A method for cooking food, said method comprising the steps of:
(a) placing food in a inner container, said inner container having rigid sides, a rigid bottom and an uncovered top;
(b) placing said inner container inside a outer container having flexible sides so that a flexible side of said flexible sides faces said uncovered top so that said flexible side can touch said food in said container through said uncovered top;
(c) pumping air from said outer container so that said flexible side applies pressure to said food through said uncovered top of said inner container but said food is not being pumped from said inner container;
(d) sealing said outer container;
(e) heating water in a water bath to a pre-selected temperature;
(f) placing said outer container with said inner container inside into said water bath so that said inner container is oriented with said top facing up;
(g) heating said first and outer container for at least a pre-selected time while maintaining said water bath at said pre-selected temperature;
(h) removing said outer container from said water bath; and
(i) removing said inner container from said outer container.

7. The method as recited in claim 6, wherein said food includes two layers wherein a first layer is a solid food and a second layer is a liquid or semi-solid food, and where in said method further comprises the step of placing said first layer on top of said second layer in said inner container.

8. The method as recited in claim 6, wherein said air pumping step further comprising the step of pumping said air from said outer container in pulses.

9. A method for cooking food, said method comprising the steps of:
(a) placing food in a inner container, said inner container being rigid and vented;
(b) placing said inner container inside a outer container having flexible side;
(c) pumping air from said outer container so that said flexible side applies pressure to said food through said uncovered top of said inner container but said food is not being pumped from said inner container;
(d) sealing said outer container;
(e) heating water in a water bath to a pre-selected temperature;
(f) placing said outer container with said inner container inside into said water bath;
(g) heating said first and outer container for at least a pre-selected time while maintaining said water bath at said pre-selected temperature;
(h) removing said outer container from said water bath; and
(i) removing said inner container from said outer container.

10. The method as recited in claim 9, further comprising the steps of
(a) placing said outer container with said inner container inside into an ice bath immediately after removing said outer container from said water bath to chill said first food; and
(b) later, reheating said outer container in said water bath before said removing said inner container from said outer container.

11. The method as recited in claim 9, wherein said outer container is placed into said water bath before said water bath has reached said pre-selected temperature.

12. The method as recited in claim 9, wherein said inner container is a serving container.

13. The method as recited in claim 9, wherein said sealing step makes said outer container air-tight.

14. The method as recited in claim 9, further comprising the step of refrigerating said outer container with said inner container inside for at least a pre-selected time before placing said outer container in said water bath.

15. A method for cooking food, said method comprising the steps of:
(a) placing food in a inner container, said inner container having rigid sides, a rigid bottom and a vented top;
(b) placing said inner container inside a outer container, said outer container having flexible side;
(c) pumping air from said outer container until said flexible side begins to apply pressure to said inner container but does not pump said food from said inner container;
(d) sealing said outer container to be air-tight;
(e) heating water in a water bath to a pre-selected temperature;
(f) immersing said outer container with said inner container inside in said water in said water bath;
(g) heating said first and outer container for at least a pre-selected time while maintaining said water bath at said pre-selected temperature, said pre-selected time being chosen to enable said water bath to heat said food in said inner container to cook; and
(h) removing said outer container from said water bath.

16. The method as recited in claim 15, further comprising the steps of:
(a) removing said inner container from said outer container; and
(b) serving said inner container.

17. The method as recited in claim 15, further comprising the steps of:
(a) chilling said outer container with said inner container inside after heating said inner container to said pre-selected time;
(b) refrigerating said chilled outer container with said inner container inside;
(c) re-immersing said refrigerated outer container with said inner container inside in a heated water bath to reheat said food in said inner container; and
(d) removing said reheated inner container from said outer container.

18. The method as recited in claim 15, wherein said food includes plural layers.

19. The method as recited in claim 19, wherein said plural layers includes a solid layer.

20. The method as recited in claim 19, wherein said solid layer is placed into said inner container last.
